(19) United States
(12) Patent Application Publication
(10) Pub. No.: US 2008/0212214 A1
(43) Pub. Date: Sep. 4, 2008

(54) FIXING STRUCTURE OF OPTICAL ELEMENT

(75) Inventors: Tatsuki Wade, Nagano (JP); Takafumi Kasuga, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/034,917

(22) Filed: Feb. 21, 2008

(30) Foreign Application Priority Data
Feb. 21, 2007 (JP) 2007-40374

(51) Int. Cl. G02B 5/08

(52) U.S. Cl. 359/839

(57) ABSTRACT

A fixing structure of an optical element such as a half mirror may include an optical element, a fixing member such as a frame which is formed with a reference surface, a first adhesive and a second adhesive which are used to fix the optical element on the reference surface. The first adhesive is coated so as to extend over the reference surface and the optical element, and the second adhesive is coated at a position where separation of the optical element from the reference surface due to thermal expansion of the first adhesive is restricted. An exposed side of the first adhesive is preferably formed in an opposite direction to an exposed side of the second adhesive with respect to the reference surface.

### CROSS REFERENCE TO RELATED APPLICATION

The present invention claims priority under 35 U.S.C. § 119 to Japanese Application No. 2007-40374 filed Feb. 21, 2007, which is incorporated herein by reference.

### FIELD OF THE INVENTION

An embodiment of the present invention relates to a fixing structure of an optical element.

### BACKGROUND OF THE INVENTION

For example, an optical head device includes an optical system for guiding an emitted light beam which is emitted from a laser light source to an objective lens, which converges the emitted light beam at a target position on a recording face of an optical disk such as a CD or a DVD, and for guiding a return light beam reflected by the optical disk to a light receiving element. Various optical elements structuring the optical system are fixed at prescribed positions of a fixing member such as a device frame with an adhesive.

For example, in an optical head device and its manufacturing method described in Japanese Patent Laid-Open No. 2005-44398, when a half mirror as an optical element is to be fixed to a device frame made of resin by using an epoxy system adhesive as a thermosetting adhesive, first, the half mirror is tightly contacted with the device frame by a pressure spring member, the epoxy system adhesive is coated on corner parts of an upper face of the half mirror, and then heat treatment is applied to cure the epoxy system adhesive. After the epoxy system adhesive has been hardened, the pressure spring piece is removed. When the half mirror is fixed to the device frame as described above, residual stress is removed from the device frame made of resin at the time of heat treatment and thus distortion of the device frame due to later temperature variation hardly occurs. Therefore, it is expected that a problem is prevented in which a mounting position of an optical element is shifted by receiving shrinkage or expanding of an adhesive due to variation of ambient temperature to cause an optical axis position of the optical element to displace.

However, materials of respective components structuring the optical head device, for example, a fixing member, the optical element and the adhesive, are respectively different from each other and thus their coefficients of thermal expansion are different. Therefore, when ambient temperature at the time of operation of the optical head device varies largely, different extensions occur in the respective optical elements. For example, an optical head device is exposed in a high temperature state by heat generation of a light source at the time of operation but returns to an ordinary temperature state at the stopping time of operation and, in this manner, expansion and shrinkage are repeated. Therefore, for example, as described in the above-mentioned Patent Reference, even in a case that distortion of the device frame itself has been removed, thermal expansion of the adhesive occurs when ambient temperature becomes in a high temperature state at the time of operation of the optical head device. In this case, expansion easily occurs more on a not-contacting side (exposed side) with the optical element or the fixing member than on a contacting side with the optical element or the fixing member and thus lifting or floating of the optical element to the fixing member occurs. Therefore, the optical element incurs positional displacement and, as a result, displacement of an optical axis occurs and thus accuracy the optical head device is deteriorated.

### SUMMARY OF THE INVENTION

In view of the problems described above, an embodiment of the present invention may advantageously provide a fixing structure of an optical element with a high degree of reliability which is less likely to incur optical axis displacement.

Thus, according to an embodiment of the present invention, there may be provided a fixing structure of an optical element including an optical element, a fixing member having a reference surface, a first adhesive and a second adhesive which are used to fix the optical element on the reference surface of the fixing member, a first adhesion part on which the first adhesive is coated so as to extend over the reference surface of the fixing member and the optical element, and a second adhesion part on which the second adhesive is coated at a position where separation of the optical element from the reference surface due to thermal expansion of the first adhesive is restricted.

According to this embodiment of the present invention, distortion due to thermal expansion of the first adhesive can be restricted or prevented by thermal expansion of the second adhesive. As a result, a fixing structure of an optical element with a high degree of reliability which is less likely to incur optical axis displacement can be obtained.

In accordance with an embodiment of the present invention, hardness after curing of the first adhesive is different from hardness after curing of the second adhesive. According to this embodiment, a fixing structure of the optical element with a high degree of reliability is obtained which is less likely to incur an optical axis displacement and, in addition, impact due to vibration or the like applied to the fixing member can be absorbed by the adhesive whose hardness after curing is lower.

In accordance with an embodiment of the present invention, the first adhesion part is formed so as to extend over the reference surface and a side face of the optical element which is abutted with the reference surface, and the second adhesion part is formed so as to extend over another face of the optical element and the fixing member.

According to the structure as described above, the first adhesion part is formed so as to extend over the reference surface and a side face of the optical element which is abutted with the reference surface, and the second adhesion part is formed so as to extend over another face of the optical element and the fixing member. Therefore, the optical element is adhesively fixed to the reference surface from both sides and thus distortion due to thermal expansion of the first adhesive can be restricted or prevented by thermal expansion of the second adhesive. Specifically, it may be structured that an exposed side of the first adhesive which is coated on the first adhesion part is formed in an opposite direction to an exposed side of the second adhesive which is coated on the second adhesion part with respect to the reference surface.

In accordance with an embodiment of the present invention, the optical element is a half mirror having an incident face and an emitting face for an emitted light beam from a laser light source, the fixing member is a frame for fixing the half mirror, and the reference surface of the frame is abutted with one of the incident face and the emitting face of the half mirror to fix the half mirror at a predetermined optical path length position from the laser light source. In this case, a fixing structure of a half mirror can be obtained with a high degree of reliability and which is less likely to incur optical axis displacement.

In the case that the optical element is a half mirror, it may be structured that the first adhesion part is formed so as to extend over the reference surface of the frame and a side face of the half mirror abutting with the reference surface, and the second adhesion part is formed so as to extend over another face of the half mirror abutting with the reference surface and the frame, and an exposed side of the first adhesive which is coated on the first adhesion part is formed in an opposite direction to an exposed side of the second adhesive which is coated on the second adhesion part with respect to the reference surface.

In accordance with an embodiment of the present invention, the first adhesion part is formed in a longer range so as to extend over the reference surface of the frame and the side face of the half mirror abutting with the reference surface, and the second adhesion part is formed in a spot-like state so as to extend over the another face abutting with the reference surface of the half mirror and the frame, and the hardness after curing of the first adhesive coated on the first adhesion part in the longer range is set to be lower than the hardness after curing of the second adhesive coated on the second adhesion part in the spot-like state.

According to the structure as described above, impact due to vibration or the like can be easily absorbed by using the first adhesive with a lower hardness. In addition, the second adhesive with a higher hardness and rigidity is coated on the second adhesion part where its coating area is small. Therefore, the fixing structure for the half mirror with a high degree of reliability is obtained which is less likely to incur an optical axis displacement and, in addition, impact due to vibration applied to the half mirror is absorbed by the first adhesive whose hardness after curing is lower.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic structure view showing an optical system of an optical head to which a fixing structure in accordance with an embodiment of the present invention is applied.

FIG. 2 is a bottom view showing an optical head in accordance with an embodiment of the present invention.

FIG. 3 is a perspective outward appearance view showing a fixing structure of a half mirror which is viewed from a light source side.

FIG. 4 is a perspective outward appearance view showing the fixing structure of the half mirror shown in FIG. 3 which is viewed from the opposite side.

FIG. 5 is a front view showing the fixing structure of the half mirror shown in FIG. 3.

FIG. 6 is a rear view showing the fixing structure of the half mirror shown in FIG. 3.

FIG. 7 is a plan view showing the fixing structure of the half mirror shown in FIG. 3.

FIG. 8 is a view showing a laser beam transmitting area of the half mirror.

FIG. 9 is a rear view showing a modified example of positions where a first adhesive is coated.

FIG. 10 is a plan view showing another modified example of positions where the first adhesive is coated.

FIG. 11 is a rear view showing a modified example of positions where a first adhesive is coated in a case that widths of a first and a second attaching parts are wider than a width of a half mirror.

FIG. 12 is a front view showing a modified example of positions where a second adhesive is coated.

### DETAILED DESCRIPTION OF THE PREFERRED EMBODIMENTS

An embodiment of the present invention will be described in detail below with reference to the accompanying drawings.

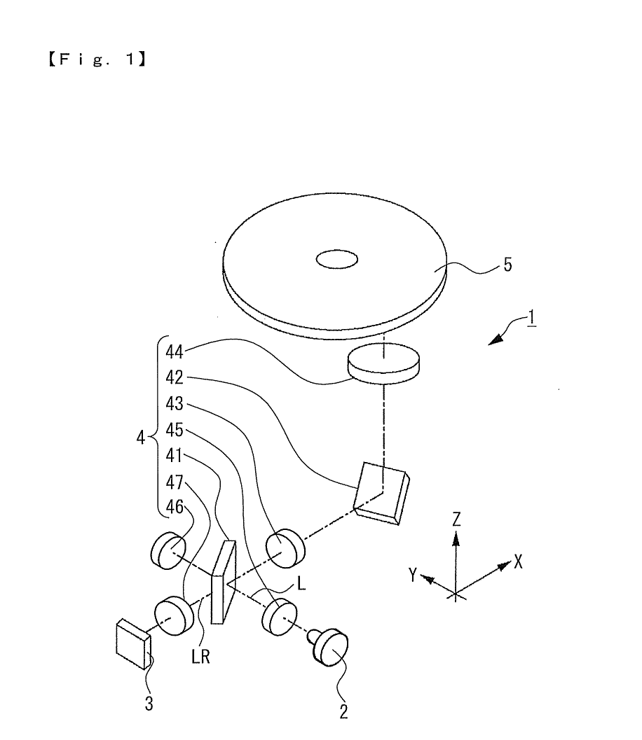

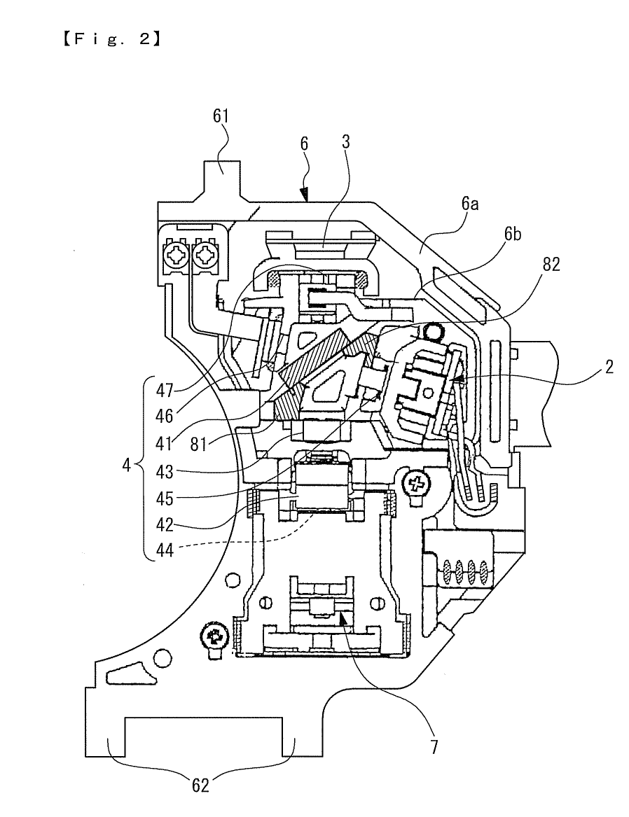

FIG. 1 is a schematic structure view showing an optical system of an optical head device in accordance with a fixing structure of an optical element in accordance with an embodiment of the present invention. FIG. 2 is a bottom view showing an optical head device.

An optical head device 1 in accordance with an embodiment of the present invention is a two-wavelength optical head device in which a first laser beam (infrared light) with a wavelength of 650 nm band and a second laser beam with a wavelength of 780 nm band are used as a laser light source 2, and which is capable of recording and reproducing into and from a DVD system disk and a CD system disk. Therefore, the laser light source 2 used in the optical head device 1 is a twin laser light source which is provided with a laser diode of AlGaInP system for emitting the first laser beam and a laser diode of AlGaAs system for emitting the second laser beam.

As shown in FIG. 1, the optical head device 1 performs reproduction and recording of information from and into an optical recording disk 5 such as a CD or a DVD. The optical head device 1 includes the laser light source 2, a light receiving element 3, and an optical system 4 for converging an emitted light beam “L”, which is emitted from the laser light source 2, on the optical recording disk 5 and for guiding a return light beam “LR” reflected by the optical recording disk 5 to the light receiving element 3. In this embodiment, the optical system 4 includes a half mirror 41, a total reflection mirror 42, a collimating lens 43, an objective lens 44, a diffraction element 45, a front monitor light receiving element 46 and a sensor lens 47.

The diffraction element 45 structuring the optical system 4 diffracts a laser beam for tracking detection into three beams, i.e., a zero-order light beam, +1st-order light beam and a −1st-order light beam. The half mirror 41 is an optical path splitting element (optical element) for reflecting the emitted light beam “L” emitted from the laser light source 2 and for transmitting the return light beam “LR” reflected by the optical recording disk 5 and thus the laser beam divided into three beams by the diffraction element 45 is partially reflected by the half mirror 41. The collimating lens 43 forms the laser beam from the half mirror 41 in a parallel light. The total reflection mirror 42 bends the parallel light to the optical recording disk 5. The objective lens 44 converges the laser beam from the total reflection mirror 42 on a recording face of the optical recording disk 5.

Further, in the optical system 4, the front monitor light receiving element 46 is disposed on an opposite side to the diffraction element 45 with respect to the half mirror 41. The front monitor light receiving element 46 monitors the emitted light beam “L” emitted from the laser light source 2 to control an output of the laser light source 2. In addition, in this embodiment, the sensor lens 47 for applying astigmatism to the return light beam “LR”, which is reflected by the recording face of the optical recording disk 5 and having passed through the objective lens 44, the total reflection mirror 42, the collimating lens 43 and the half mirror 41, is disposed between the half mirror 41 and the light receiving element 3.

The optical system 4 includes, when the coordinate axes perpendicular to each other are set to be an X-axis, a Y-axis and a Z-axis (shown by the arrows “X”, “Y” and “Z” in FIG. 1), the diffraction element 45 for diffracting the laser beam emitted from the laser light source 2 in the Y-axis direction into the three beams, the half mirror 41 for reflecting the laser beam (emitted light beam “L”) in the X-axis direction, the collimating lens 43 for forming the laser beam (emitted light beam “L”) from the half mirror 41 into a parallel light, the total reflection mirror 42 for bending the laser beam (emitted light beam “L”) upward in the Z-axis direction, the objective lens 44 for converging the laser beam (emitted light beam “L”) from the total reflection mirror 42 on the recording face of the optical recording disk 5, the light receiving element 46 for front monitor, the sensor lens 47 and the like. Further, in the optical system 4, the laser beam (emitted light beam “L”) is reflected by the recording face of the optical recording disk 5 to be the return light beam “LR”, and the laser beam returns the optical path in a reverse direction and transmits through the half mirror 41 to be received by the light receiving element 3.

In the optical head device 1, the laser light source 2, the light receiving element 3, and the optical elements such as the diffraction element 45, the half mirror 41, the collimating lens 43, the total reflection mirror 42, the objective lens 44, the front monitor light receiving element 46 and the sensor lens 47, which structure the optical system 4, are, as shown in FIG. 2, mounted on the device frame 6 in a state that their positions and inclinations in the X-axis, the Y-axis and the Z-axis have been adjusted respectively.

As shown in FIG. 2, in this embodiment, the device frame 6 of the optical head device 1 is comprised of a mainframe 6a, which is a frame member made of resin, and a metal subframe 6b. The subframe 6b is held by the mainframe 6a in a state that the subframe 6b is disposed on an inner side of the mainframe 6a. Both ends of the mainframe 6a are formed with a first bearing part 61 and a second bearing part 62 which engage with a feed screw shaft and a guide shaft of a disk drive device (not shown) so that the optical head device 1 is capable of being driven in a radial direction of the optical recording disk 5.

An objective lens drive mechanism 7 is mounted on the mainframe 6a. The objective lens drive mechanism 7 is provided with the objective lens 44. Therefore, a position of the objective lens 44 is servo-controlled in a tracking direction and in a focusing direction by the objective lens drive mechanism 7. In FIG. 2, the objective lens 44 is disposed under the total reflection mirror 42 and thus the objective lens 44 is not shown in the drawing.

In this embodiment, the half mirror 41 is adhesively bonded and fixed to a center region of the subframe 6b. Further, the subframe 6b is provided with a first attaching part 81 and a second attaching part 82, and the half mirror 41 is disposed so as to stretch over the first attaching part 81 and the second attaching part 82. In other words, the half mirror 41 is disposed in the optical path between the laser light source 2 and the objective lens 44 for irradiating the laser beam “L” emitted from the laser light source 2 on the optical recording disk 5. The diffraction element 45 is mounted on a side of the half mirror 41 and the laser light source 2 is disposed on a side of the diffraction element 45.

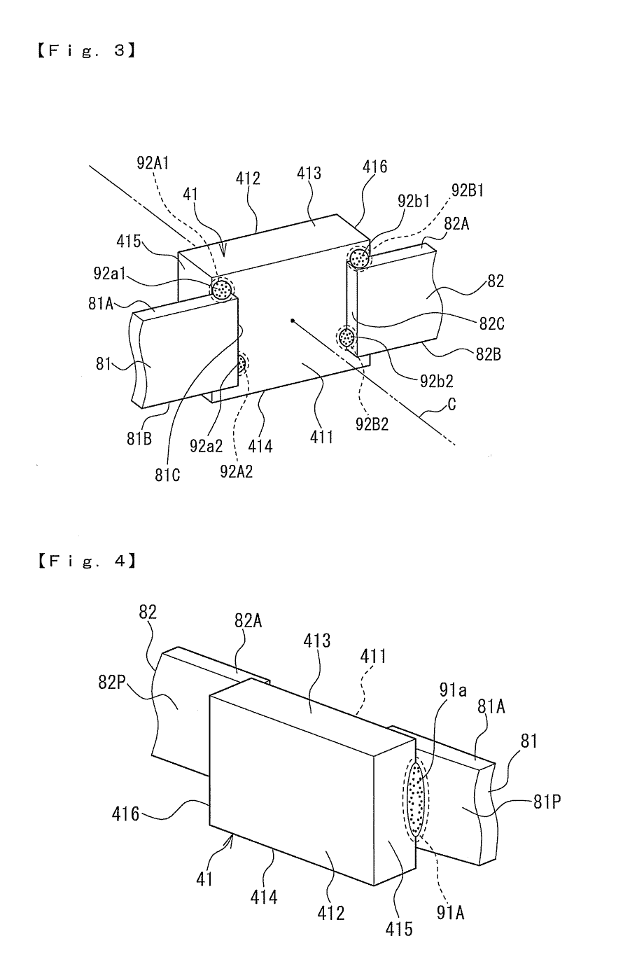

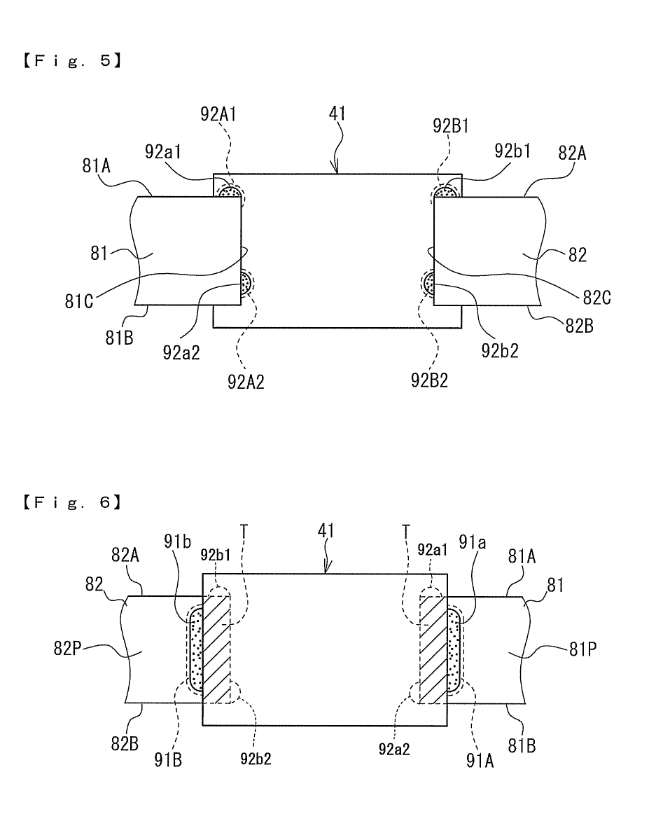

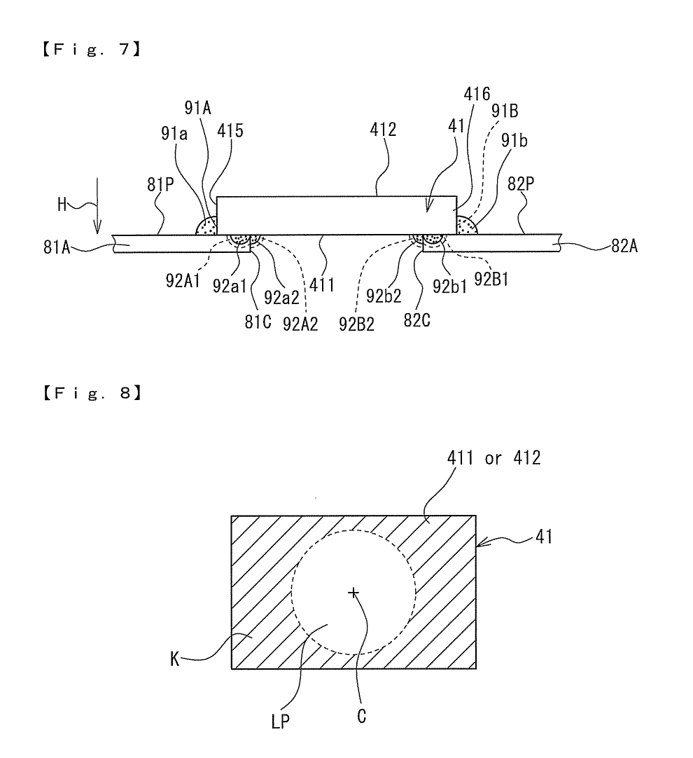

FIG. 3 is a perspective outward appearance view showing a fixing structure of the half mirror which is viewed from a light source side. FIG. 4 is a perspective outward appearance view showing the fixing structure of the half mirror shown in FIG. 3 which is viewed from an optically recorded information disk side. FIG. 5 is a front view showing the fixing structure of the half mirror shown in FIG. 3, FIG. 6 is a rear view showing the fixing structure of the half mirror shown in FIG. 3, and FIG. 7 is a plan view showing the fixing structure of the half mirror shown in FIG. 3. FIG. 8 is a view showing a laser beam transmitting area of the half mirror. The fixing structure in accordance with this embodiment will be described below as an example where the half mirror 41 is used as an optical element, the device frame 6 is used as a fixing member, and the half mirror 41 is fixed to the device frame 6 with an adhesive.

As shown in FIGS. 3 through 8, the half mirror 41 is formed in a rectangular parallelepiped body having a flat plate shape, which is provided with an incident face 411 and an emitting face 412. The half mirror 41 is provided with the incident face (face on the light source side) 411, which reflects the emitted light beam “L” emitted from the laser light source 2 and to which the return light beam “LR” reflected by the recording face of the optical recording disk 5 is incident, and the emitting face (face on the light receiving element side) 412 which emits the return light beam “LR” to the light receiving element 3. Further, the half mirror 41 is provided with an upper face (first end face) 413 and an under surface (second end face) 414, and a left side face (side face on the first attaching part side) 415 and a right side face (side face on the first attaching part side) 416, which respectively face across an optical axis “C” (laser beam).

In this embodiment, sizes of the incident face 411 and the emitting face 412 are, as shown in FIG. 8, set to be larger than a transmitting area “LP” of the laser beam (area surrounded by the dotted line). An area “K” where an adhesive is capable of being coated is provided on an outer side of the transmitting area “LP”. The transmitting area “LP” of the laser beam is the area surrounded by the dotted line, which is an area formed in a substantially circular shape with the optical axis “C” as a center and where the optical axis “C” of the laser beam is located at a substantially center of the incident face 411 and the emitting face 412 formed in a flat plate shape.

In the first attaching part 81 and the second attaching part 82 which are formed in the subframe 6b, faces 81P and 82P with which the incident face 411 of the half mirror 41 is abutted, are disposed at positions which are set to be a prescribed optical path length from the laser light source 2, in other words, the faces 81P and 82P are reference surfaces. One of end portions of the incident face 411 is abutted with the reference surface 81P of the first attaching part 81 and similarly, the other of the end portions of the incident face 411 is abutted with the reference surface 82P of the second attaching part 82. As a result, the half mirror 41 is positioned in the direction of the optical axis “C”. In this embodiment, areas where the half mirror 41 and the reference surfaces 81P and 82P are abutted and overlapped are shown as an abutting part “T” as shown in FIG. 6. The abutting part “T” is located within the above-mentioned area “K” and an area and the like of the abutting part “T” is not limited to this embodiment.

Next, a first adhesion part 91 and a second adhesion part 92 will be described below. The half mirror 41 is disposed so as to stretch over the first attaching part 81 and the second attaching part 82. The incident face 411 of the half mirror 41 is abutted with the reference surface 81P of the first attaching part 81 and the reference surface 82P of the second attaching part 82. In addition, a first adhesive is coated on a first adhesion part 91 and a second adhesive is coated on a second adhesion part 92.

The first adhesion part 91 is, as shown in FIG. 4, is formed in a longer range by one position in each of the first attaching part 81 and the second attaching part 82. Specifically, the first adhesion part 91A is formed so as to extend over both faces of the reference surface 81P and a left side face 415 of the half mirror 41. A first adhesive 91a is coated on the first adhesion part 91A in a longer range at a center portion of the abutting portion of the reference surface 81P with the half mirror 41. Similarly, the first adhesion part 91B is formed so as to extend over both of the reference surface 82P and its right side face 416 and a first adhesive 91b is coated on the first adhesion part 91B in a longer range at a center portion of the abutting portion of the reference surface 82P with the half mirror 41.

In this embodiment, the first adhesive 91a and the first adhesive 91b are coated by substantially the same quantity, the same area and the same position by using an adhesive having the same characteristic. However, the present invention is not limited to this embodiment.

In this embodiment, the second adhesion part 92 is, as shown in FIGS. 3 and 5, provided at two positions shown by the notational symbols 92A1 and 92A2 on the first attaching part 81 in a spot-like state. Further, the second adhesion part 92 is provided at two positions shown by the notational symbols 92B1 and 92B2 on the second attaching part 82 in a spot-like state.

On the first attaching part 81 side, the second adhesion part 92 is formed at two positions, i.e., the first end face 81A (upper end face in FIG. 5) and the second end face 81C (side face in FIG. 5). Specifically, a second adhesive 92a1 is coated in a spot-like state on a second adhesion part 92A1 formed on the upper end face of the first attaching part 81 so as to extend over the first end face 81A of the first attaching part 81 and the incident face 411 of the half mirror 41. In addition, a second adhesive 92a2 is coated in a spot-like state on the second adhesion part 92A2 formed on a lower side of the first attaching part 81 so as to extend over the second end face 81C, which is perpendicular to the first end face 81A, and the incident face 411 of the half mirror 41.

Similarly, on the second attaching part 82 side, the second adhesion part 92B is formed at two positions, i.e., on a first end face 82A (upper end face in FIG. 5) and a second end face 82C (side face in FIG. 5). In the second adhesion part 92B1, a second adhesive 92b1 is coated in a spot-like state so as to extend over the first end face 82A that is an upper end face of the second attaching part 82 and the incident face 411 of the half mirror 41. In addition, in the second adhesion part 92B2 formed on a lower side of the second attaching part 82, a second adhesive 92b2 is coated in a spot-like state so as to extend over the second end face 82C which is perpendicular to the first end face 82A and the incident face 411 of the half mirror 41.

In this embodiment, the second adhesives 92a1 and 92a2 and the second adhesives 92b1 and 92b2 are coated by substantially the same quantity, the same area and the same position by using an adhesive having the same characteristic. However, the present invention is not limited to this embodiment.

As described above, in this embodiment, the first adhesion parts 91A and 91B are structured in which the first adhesives 91a and 91b are coated on the reference surfaces 81P and 82P in a longer range so as to extend over the half mirror 41 and the first attaching part 81 and the second attaching part 82. In addition, the second adhesion parts 92A1, 92A2, 92B1 and 92B2 are structured in which the second adhesives 92a1, 92a2, 92b1 and 92b2 are coated in a spot-like state. In this manner, the half mirror 41 is fixed to the first and the second attaching parts 81 and 82 with the first adhesives 91a and 91b applied in a longer range so that distortion due to thermal expansion of the first adhesives 91a and 91b is restrained or prevented by thermal expansion of the second adhesives 92a1, 92a2, 92b1 and 92b2 which are applied in a spot-like shape. Therefore, a fixing structure for the half mirror 41 is obtained with a high degree of reliability in which displacement of the optical axis is less likely to occur.

More specifically, as shown in FIGS. 6 and 8, the first adhesion parts 91A and 91B are disposed on an outer side of the abutting parts “T” with respect to the transmitting area “LP” of the laser beam, and the second adhesion parts 92A1, 92A2, 92B1 and 92B2 are disposed on an inner side or its vicinity of the abutting part “T”. In this embodiment, as shown in FIG. 8, the substantially center portions of the incident face 411 and the emitting face 412 of the half mirror 41 are formed as the transmitting area “LP” of the laser beam (area surrounded by the dotted line) which is formed in a substantially circular shape with the optical axis “C” of the laser beam as a center. In other words, in this embodiment, the first adhesion parts 91A and 91B are formed at positions deviated from the transmitting area “LP”, and the second adhesion parts 92A1, 92A2, 92B1 and 92B2 are formed at positions near the transmitting area “LP”.

In other words, the second adhesion parts 92A1, 92A2, 92B1 and 92B2 are located at roughly corner portions of the half mirror 41 which is formed in a quadrangle. The corner portion is, as shown in FIG. 8, an area of four comers near end sides of the half mirror 41 and, more specifically, it is the outer side area “K” of the transmitting area “LP” of the laser beam which is formed in the incident face 411 and the emitting face 412. An adhesive is coated on the second adhesion parts 92A1, 92A2, 92B1 and 92B2 so as not to interfere with the transmitting area “LP” of the laser beam in the half mirror 41 and the transmitting area “LP” of laser beam is secured.

Further, as shown in FIG. 7, the first adhesion part 91A and the second adhesion parts 92A1 and 92A2 are disposed at roughly symmetrical positions each other (face each other) with respect to the reference surface 81P of the first attaching part 81. Specifically, an exposed side of the first adhesive 91a coated on the first adhesion part 91A, in other words, a side which is not contacted with the incident face 411 of the half mirror 41 and a side which is not contacted with the reference surface 81P of the first attaching part 81 is located on the upper side in the drawing. On the other hand, an exposed side of the second adhesive 92a1 (92a2) coated on the second adhesion part 92A1 (92A2), in other words, a side which is not contacted with the incident face 411 and the first end face 81A (second end face 81C) is located on the lower side in the drawing. In other words, the exposed side of the first adhesive 91a and the exposed sides of the second adhesives 92a1 and 92a2 are disposed at roughly symmetrical positions each other (face each other) with respect to the reference surface 81P where the half mirror 41 is abutted with the first attaching part 81.

As described above, the exposed side of the first adhesive 91a and the exposed sides of the second adhesives 92a1 and 92a2 are disposed at roughly symmetrical positions each other (face each other) with respect to the reference surface 81P of the first attaching part 81 with which the half mirror 41 is abutted. In other words, the exposed side of the first adhesive 91a and the exposed sides of the second adhesives 92a1 and 92a2 are faced in opposite directions to each other with respect to the reference surface 81P of the first attaching part 81 with which the half mirror 41 is abutted. Therefore, even when the optical head device 1 is operated and its ambient temperature becomes to be in a high temperature state and as a result, even when the first adhesive 91a and the second adhesives 92a1 and 92a2 are thermally expanded, they interfere each other to be less likely to expand because the exposed sides which are likely to expand (not-contacting side) are disposed at roughly symmetrical positions each other so as to interpose the reference surface 81P. Therefore, the half mirror 41 is hardly floated or lifted from the reference surface 81P of the first attaching part 81, which is different from the conventional case. Accordingly, a fixing structure of the half mirror 41 with a high degree of reliability is obtained in which positional displacement of the half mirror 41 and an optical axis displacement hardly occurs. In addition, in this embodiment, the exposed side of the first adhesive 91a and the exposed side of the second adhesives 92a1 and 92a2 are formed in opposite directions to each other with respect to the optical axis direction and thus variation of the optical path length is reduced.

Similarly, as shown in FIG. 7, the first adhesion part 91B and the second adhesion parts 92B1 and 92B2 are disposed at roughly symmetrical positions each other (face each other) with respect to the reference surface 82P of the second attaching part 82. Specifically, an exposed side of the first adhesive 91b coated on the first adhesion part 91B, in other words, a side which is not contacted with the incident face 411 of the half mirror 41 and the reference surface 82P of the second attaching part 82 is located on the upper side in the drawing. On the other hand, an exposed side of the second adhesive 92b1 (92b2) coated on the second adhesion part 92B1 (92B2), in other words, a side which is not contacted with the incident face 411 and the first end face 82A (second end face 82C) is located on the lower side in the drawing. In other words, the exposed side of the first adhesive 91b and the exposed sides of the second adhesives 92b1 and 92b2 are disposed at roughly symmetrical positions each other (face each other) with respect to the reference surface 82P where the half mirror 41 is abutted with the second attaching part 82.

As described above, the exposed side of the first adhesive 91b and the exposed sides of the second adhesives 92b 1 and 92b2 are disposed at roughly symmetrical positions each other (face each other) with respect to the reference surface 82P of the second attaching part 82 with which the half mirror 41 is abutted. In other words, the exposed side of the first adhesive 91b and the exposed sides of the second adhesives 92b1 and 92b2 are faced in opposite directions to each other with respect to the reference surface 82P of the second attaching part 82. Therefore, even when the optical head device 1 is operated to cause its ambient temperature to be in a high temperature state and as a result, even when the first adhesive 91b and the second adhesives 92b1 and 92b2 are thermally expanded, they interfere each other to be less likely to expand because the exposed sides which are likely to expand (not-contacting sides) are disposed at roughly symmetrical positions each other so as to interpose the reference surface 82P. Therefore, the half mirror 41 is hardly floated and lifted from the reference surface 82P of the second attaching part 82, which is different from the conventional case. Accordingly, a fixing structure of the half mirror 41 with a high degree of reliability is obtained in which positional displacement of the half mirror 41 and an optical axis displacement hardly occurs. In addition, in this embodiment, the exposed side of the first adhesive 91b and the exposed sides of the second adhesives 92b1 and 92b2 are formed in opposite directions to each other with respect to the optical axis direction and thus variation of the optical path length can be reduced.

In addition, in this embodiment, the first adhesives 91a and 91b and the second adhesives 92a1, 92a2, 92b1 and 92b2 are used in which hardness after curing of the first adhesives 91a and 91b are different from that of the second adhesives 92a1, 92a2, 92b1 and 92b2. Specifically, the hardness of the first adhesives 91a and 91b are lower than that of the second adhesives 92a1, 92a2, 92b1 and 92b2.

The present invention is not limited to the above-mentioned embodiment and is applicable to a case that the hardness of the first adhesives 91a and 91b are different from the hardness of the second adhesives 92a1, 92a2, 92b1 and 92b2.

Further, in this embodiment, the hardness after curing of the first adhesives 91a and 91b is set to be lower than that of the second adhesives 92a1, 92a2, 92b1 and 92b2, and the first adhesives 91a and 9 1b are coated in a longer range on the reference surfaces 81P and 82P of the first and the second attaching parts 81 and 82 with which the incident face 411 of the half mirror 41 is abutted. Therefore, impact due to vibration or the like which is applied to the device frame 6 is absorbed by the first adhesives 91a and 91b to restrict the impact from transmitting to the half mirror 41.

On the other hand, the hardness after curing of the second adhesives 92a1, 92a2, 92b1 and 92b2 is set to be higher than that of the first adhesives 91a and 91b, and the second adhesives 92a1, 92a2, 92b1 and 92b2 are coated in a spot-like state between the incident face 411 of the half mirror 41 and the first and the second attaching parts 81 and 82. Therefore, since the hardness after curing of the second adhesives 92a1, 92a2, 92b1 and 92b2 is higher than that of the first adhesives 91a and 91b, distortion due to thermal expansion of the first adhesive is restricted or prevented by the second adhesives 92a1, 92a2, 92b1 and 92b2.

In this embodiment, the first adhesives 91a and 91b are coated on an outer side of the abutting parts “T” with respect to the transmitting area “LP” of the laser beam, and the second adhesives 92a1, 92a2, 92b1 and 92b2 are coated on an inner side or its vicinity of the abutting part “T”. As described above, when the second adhesives 92a1, 92a2, 92b1 and 92b2 are to be coated near the transmitting area “LP” of the laser beam, in order that the second adhesives 92a1, 92a2, 92b1 and 92b2 are coated so as not to interfere with the transmitting area “LP” of the laser beam, an area of the half mirror 41 which is permitted to be coated becomes small. Accordingly, the first adhesives 91a and 91b whose hardness is relatively low are coated in a wide area in the first adhesion parts 91A and 91B which can secure a wide coating area to the half mirror 41 and thus impact of vibration is easily absorbed. On the other hand, the second adhesives 92a1, 92a2, 92b1 and 92b2 whose hardness and rigidity are relatively high are coated in a small area in the second adhesion parts 92A and 92B where coating area is limited. In this manner, the fixing structure of the half mirror 41 with a high degree of reliability is obtained which is less likely to incur an optical axis displacement and, in addition, impact due to vibration or the like applied to the half mirror 41 is absorbed by the first adhesives 91a and 91b whose hardness after curing is lower.

As described above, in this embodiment, the first adhesion parts 91A and 91B are formed so as to extend over the reference surface 81P of the first attaching part 81, the reference surface 82P of the second attaching part and the right side face 415 and the left side face 416 of the half mirror 41. In addition, the second adhesion parts 92A1, 92A2, 92B1 and 92B2 are disposed at a roughly symmetrical (face each other) position to each other with respect to the reference surfaces 81P and 82P. In this manner, according to this embodiment, the first adhesives which are coated on the first adhesion parts 91A and 91B are coated at positions where separation of the half mirror 41 due to thermal expansion from the reference surface 81P and the reference surface 82P is restricted. Further, the second adhesive is coated on the second adhesion parts 92A1, 92A2, 92B1 and 92B2 and thus the half mirror 41 is firmly fixed to the reference surfaces 81P and 82P. Therefore, the fixing structure of the half mirror 41 (optical element) with a high degree of reliability is obtained which is less likely to incur an optical axis displacement. In other words, even when the optical head device 1 is operated to cause its ambient temperature to be in a high temperature state and as a result, even when the first adhesives 91a, 91b and the second adhesives 92a1, 92a2, 92b1 and 92b2 are thermally expanded, they interfere each other to be less likely to expand because the exposed sides which are likely to expand (not-contacting side) are disposed at roughly symmetrical positions each other so as to interpose the reference surface 81P.

Further, the hardness of the first adhesives 91a and 91b is set to be lower than that of the second adhesives 92a1, 92a2, 92b1 and 92b2. In other words, the first adhesives 91a and 91b whose hardness is relatively low are coated in a longer state or in a wide area in the first adhesion parts 91A and 91B which can secure a wide coating area to the half mirror 41 and thus impact of vibration or the like is easily absorbed. On the other hand, the second adhesives 92a1, 92a2, 92b1 and 92b2 whose hardness and rigidity are relatively high are coated in a small area or a spot-like state in the second adhesion parts 92A and 92B whose coating area is limited and small. In this manner, the fixing structure of the half mirror 41 with a high degree of reliability is obtained which is less likely to occur an optical axis displacement and, in addition, impact due to vibration or the like applied to the half mirror 41 is absorbed by the first adhesives 91a and 91b whose hardness after curing is lower.

Further, since the second adhesives 92a1, 92a2, 92b1 and 92b2 are applied to the corner portions of the half mirror 41, the second adhesives 92a1, 92a2, 92b1 and 92b2 can be coated so as not to interfere with the transmitting area “LP” of the laser beam in the half mirror 41 and thus the transmitting area “LP” of the laser beam can be secured.

The embodiment described above illustrates the fixing structure in which a transmission type optical element such as the half mirror 41 that transmits an emitted light beam emitted from the laser light source 2 is fixed to the device frame 6. Alternatively, the present invention may be utilized in a fixing structure of a case that an optical element such as a reflection member like a reflecting mirror or the like is fixed.

Further, in this embodiment, the first adhesive or the second adhesive are coated so as to extend over the reference surfaces 81P, 82P and the left side face 415 and the right side face 416 of the half mirror 41 but the present invention is not limited to this embodiment.

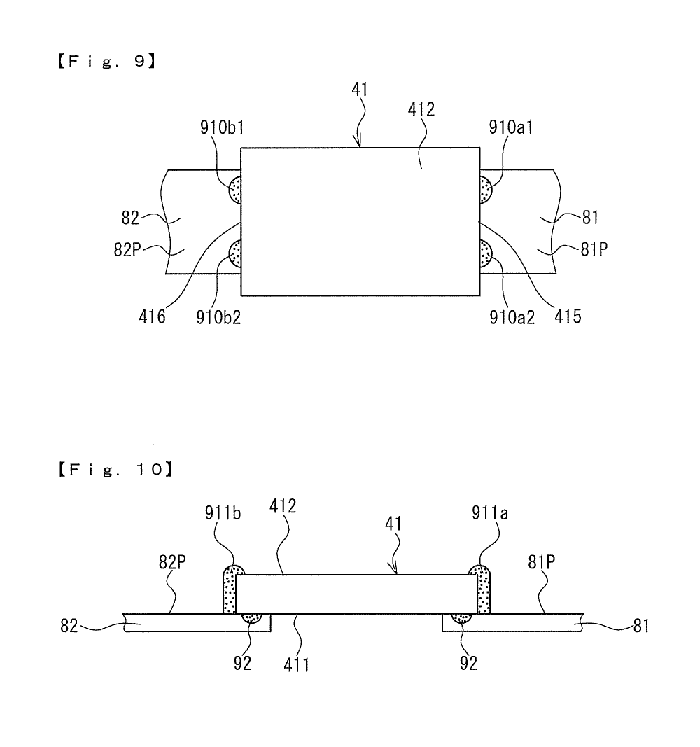

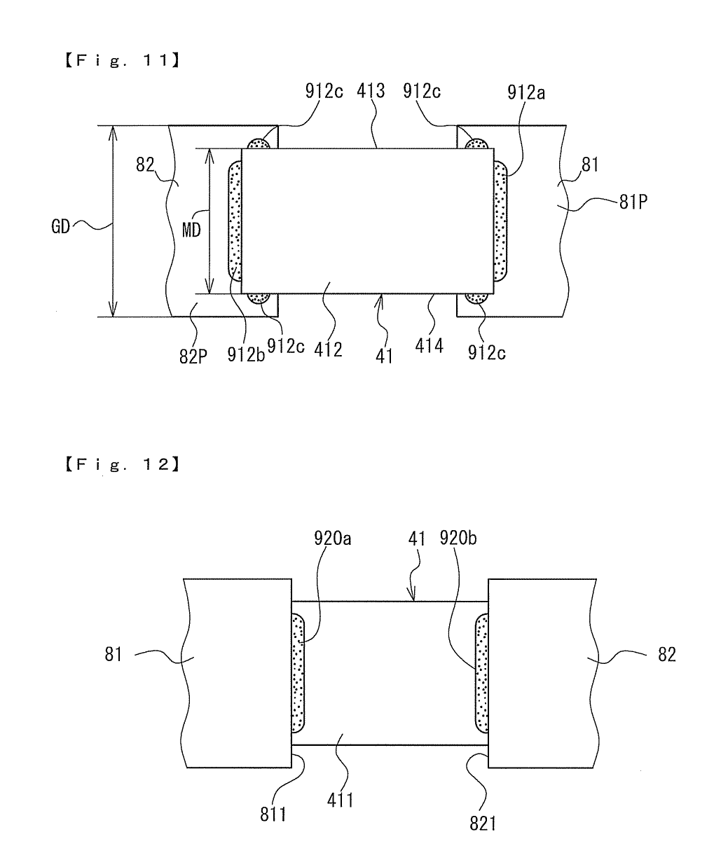

In this embodiment, as shown in FIG. 4, in the first adhesion parts 91A and 91B, the first adhesives 91a and 91b are coated continuously in a vertical direction in the drawing, i.e., in a longer range so as to extend over the left side face 415, the right side face 416 of the half mirror 41 and the reference surface 81P of the first attaching part 81 and the reference surface 82P of the second attaching part 82. However, the present invention is not limited to this embodiment. For example, as shown in FIG. 9, the first adhesives 910a1, 910a2, 910b1 and 910b2 may be partially and discontinuously coated, in other words, in a spot-like manner, in the vertical direction in the drawing on the left side face 415 and the right side face 416 of the half mirror 41. Further, as shown in FIG. 10, the first adhesives 911a and 911b may be coated so as to extend over the emitting face 412 which is an opposite side face to the incident face 411 abutted with the reference surfaces 81P, 82P of the half mirror 41 to cover the right and left side faces 415 and 416 of the half mirror 41. Further, the first adhesives 911a and 911b may be interposed between the half mirror 41 and the reference surfaces 81P and 82P which are abutted with the incident face 411 of the half mirror 41. Further, as shown in FIG. 11, for example, in a case that a width “GD” of the first and the second attaching parts 81 and 82 is wider than a width “MD” of the half mirror 41, the first adhesive 912c is coated so as to extend over the reference surfaces 81P, 82P and an upper face 413 and an under face 414 of the half mirror 41 and, in addition, the first adhesives 912a and 912b may be coated in the same manner as the above-mentioned embodiment.

In addition, according to an embodiment of the present invention, the first and the second adhesives may be coated so as to extend over the face 411 of the half mirror 41 abutting with the reference surfaces 81P and 82P and either face except the reference surfaces 81P and 82P. For example, as shown in FIG. 12, in a case that the width of the first and the second attaching parts 81 and 82 is wider than that of the half mirror 41 (see FIG. 11), the second adhesives 920a and 920b may be formed so as to extend over the face of the half mirror 41 abutting with the reference surface (incident face 411) and end faces 811, 821 of the first and the second attaching parts 81 and 82 which are opposite to each other.

Further, in the embodiment described above, the hardness of the first adhesives 91a and 91b is different from that of the second adhesives 92a1, 92a2, 92b1 and 92b2. However, the present invention is not limited to this embodiment. Adhesives having the same hardness may be used according to an optical element to be fixed, its fixed position, its adhering area and the like. In addition, the positions where the first and the second adhesives are coated, their quantities and the like are not limited to this embodiment.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A fixing structure of an optical element comprising:
an optical element;
a fixing member which is formed with a reference surface;
a first adhesive and a second adhesive which are used to fix the optical element on the reference surface of the fixing member;
a first adhesion part on which the first adhesive is coated so as to extend over the reference surface of the fixing member and the optical element; and
a second adhesion part on which the second adhesive is coated at a position where separation of the optical element from the reference surface due to thermal expansion of the first adhesive is restricted.

2. The fixing structure of the optical element according to claim 1, wherein hardness after curing of the first adhesive is different from hardness after curing of the second adhesive.

3. The fixing structure of the optical element according to claim 1, wherein
the first adhesion part is formed so as to extend over the reference surface and a side face of the optical element which is abutted with the reference surface; and
the second adhesion part is formed so as to extend over another face of the optical element and the fixing member.

4. The fixing structure of the optical element according to claim 3, wherein an exposed side of the first adhesive which is coated on the first adhesion part is formed in an opposite direction to an exposed side of the second adhesive which is coated on the second adhesion part with respect to the reference surface.

5. The fixing structure of the optical element according to claim 1, wherein
the optical element is a half mirror having an incident face and an emitting face for an emitted light beam emitted from a laser light source,
the fixing member is a frame for fixing the half mirror, and
the reference surface of the frame is abutted with one of the incident face and the emitting face of the half mirror for fixing the half mirror at a predetermined optical path length position from the laser light source.

6. The fixing structure of the optical element according to claim 5, wherein
the first adhesion part is formed so as to extend over the reference surface of the frame and a side face of the half mirror abutting with the reference surface, and
the second adhesion part is formed so as to extend over another face of the half mirror abutting with the reference surface and the frame, and
an exposed side of the first adhesive which is coated on the first adhesion part is formed in an opposite direction to an exposed side of the second adhesive which is coated on the second adhesion part with respect to the reference surface.

7. The fixing structure of the optical element according to claim 6, wherein hardness after curing of the first adhesive is different from hardness after curing of the second adhesive.

8. The fixing structure of the optical element according to claim 5, wherein
the first adhesion part is formed in a longer range so as to extend over the reference surface of the frame and the side face of the half mirror abutting with the reference surface, and
the second adhesion part is formed in a spot-like state so as to extend over the another face of the half mirror abutting with the reference surface and the frame, and
the hardness after curing of the first adhesive coated on the first adhesion part in the longer range is set to be lower than the hardness after curing of the second adhesive coated on the second adhesion part in the spot-like state.
